(19) United States
(12) Patent Application Publication
(10) Pub. No.: US 2013/0098079 A1
(43) Pub. Date: Apr. 25, 2013

(54) Mist cooling assembly

(71) Applicants: Graham Robert Apolony, New South Wales (AU); Phillip Michael Lourey, New South Wales (AU); Fidel Dela Paz, New South Wales (AU)

(72) Inventors: GRAHAM ROBERT APOLONY, NEW SOUTH WALES (AU); PHILLIP MICHAEL LOUREY, NEW SOUTH WALES (AU)

(73) Assignees: GRAHAM ROBERT APOLONY, NEW SOUTH WALES (AU); FIDEL DELA PAZ, NEW SOUTH WALES (AU); PHILLIP MICHAEL LOUREY, NEW SOUTH WALES (AU)

(21) Appl. No.: 13/656,767

(22) Filed: Oct. 22, 2012

(30) Foreign Application Priority Data
Oct. 20, 2011 (AU) 2011904338

(51) Int. Cl. F28C 3/08; F25D 17/06; B01F 3/04

(52) U.S. Cl. 62/91; 261/78.1

(57) ABSTRACT

A mist cooling assembly (20) comprising a housing (21), a plurality of water misting outlets (55) generally aligned in a row along said housing (21), the misting outlets (55) being spaced along a misting width, and at least one air flow source (50) disposed within said housing (21) for supplying an air flow (59), wherein the housing (21) comprises at least one air flow outlet (36) adapted to direct the air flow (59) in use adjacent said misting outlets (55) and substantially spanning the misting width.

### CROSS REFERENCE TO RELATED CO-PENDING APPLICATIONS

This application claims the benefit of Australian application Serial No. 2011904338 filed Oct. 20, 2011 and entitled “A mist cooling assembly”, the contents of which are expressly incorporated herein by reference.

### FIELD OF THE INVENTION

The present invention relates to cooling assembly and in particular to a mist cooling assembly.

The invention has been developed primarily for use in cooling areas and will be described hereinafter with reference to this application. However, it will be appreciated that the invention is not limited to this particular field of use.

### BACKGROUND OF THE INVENTION

The commercially available mist cooling assemblies have several disadvantages, including unattractive appearance, large size and high noise levels.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect, the present invention provides a mist cooling assembly comprising:

a housing;

a plurality of water misting outlets generally aligned in a row along said housing, the misting outlets being spaced along a misting width; and

at least one air flow source disposed within said housing for supplying an air flow;

wherein the housing comprises at least one air flow outlet adapted to direct the air flow in use adjacent said misting outlets and substantially spanning the misting width.

In a preferred embodiment, the misting outlets are oriented to spray mist in use in a substantially horizontal direction.

In a preferred embodiment, the at least one air flow outlet directs the at least one air flow in use in a substantially horizontal direction.

In a preferred embodiment, the at least one air flow outlet directs the at least one air flow in use in a direction which is substantially parallel to the general direction of spray mist from the misting outlets.

In a preferred embodiment, the at least one air flow outlet directs the at least one air flow in use substantially from behind said misting outlets.

In a preferred embodiment, wherein the at least one air flow outlet directs the at least one air flow in use substantially from above said misting outlets.

In a preferred embodiment, the at least one air flow outlet directs the at least one air flow in use substantially vertically spaced from said misting outlets.

In a preferred embodiment, the at least one air flow outlet delivers the air flow in use toward each lateral side of each nozzle.

In a preferred embodiment, the housing further comprises at least one air direction flange adjacent said at least one air flow outlet.

In a preferred embodiment, the at least one air direction flange is generally angled toward the misting outlets.

In a preferred embodiment, the misting outlets are disposed along a substantially horizontal axis.

Advantageously, these features individually or as any combination thereof assist in spreading the mist from the misting outlets in use.

In a preferred embodiment, the mist cooling assembly further comprises at least one liquid supply pipe, wherein the misting outlets are spaced along the at least one liquid supply pipe.

In a preferred embodiment, the misting outlets are nozzles.

In a preferred embodiment, the at least one air flow source comprises an elongated fan.

In a preferred embodiment, the housing comprises a plurality of spaced apertures respectively for said misting outlets.

In a preferred embodiment, the housing comprises at least one mounting means for mounting the housing to a structure.

In another aspect, the present invention provides a mist cooling assembly comprising:

a plurality of misting outlets generally aligned in a row; and

at least one air flow outlet for directing at least one air flow in use generally adjacent said misting outlets.

In another aspect, the present invention provides a method of cooling an area, the method comprising:

providing a plurality of misting outlets generally aligned in a horizontal row;

supplying water under pressure to said misting outlets to expel water as mist through said misting outlets in a substantially horizontal direction;

directing at least one air flow in a substantially horizontal direction adjacent and above said misting outlets to spread the expelled mist to the area to be cooled.

Preferably, the method further comprises the step of:

directing the at least one air flow from a position disposed behind said misting outlets.

Preferably, the method further comprises the step of:

directing the at least one air flow toward each lateral side of each nozzle

Advantageously, the assembly is able to cool a large area in use.

Preferably, the at least one liquid supply pipe includes an end for connection to a liquid supply source.

Advantageously, the housing can provide an attractive external appearance for the mist cooling assembly.

Preferably, the housing comprises a front wall and the at least one air flow outlet is formed in the front wall.

Preferably, the at least one air flow outlet spans a substantially horizontal width of the housing.

Preferably, the apertures are disposed forwardly of the at least one air flow in use.

Preferably, the housing comprises a front wall and an internal channel formed in the front wall, wherein the misting outlets are housed in the internal channel.

Advantageously, this protects and substantially hides the misting outlets.

Advantageously, the housing protects and substantially hides the at least one air flow source and suppresses the noise produced thereby.

Preferably, the housing comprises at least one air inlet.

Preferably, the housing comprises a bottom wall and the at least one air inlet is disposed in the bottom wall. Preferably, the housing comprises a rear wall and the at least one air inlet is disposed in the rear wall.

Preferably, the housing comprises at least one mounting means for mounting the housing to a structure. Preferably, the mounting means comprises at least one mounting aperture. Preferably, the housing comprises a rear wall and the at least one mounting means is disposed in the rear wall. Preferably, the housing comprises a bottom wall and the at least one mounting means is disposed in the bottom wall. Preferably, the housing comprises a top wall and the at least one mounting means is disposed in the top wall.

The present invention also provides a structure having the mist cooling assembly of the above mounted thereto.

Other aspects of the invention are also disclosed.

### BRIEF DESCRIPTION OF THE DRAWINGS

Notwithstanding any other forms which may fall within the scope of the present invention, preferred embodiments of the invention will now be described, by way of examples only, with reference to the accompanying drawings in which:

FIG. 1 is a top front left perspective view of a mist cooling assembly in accordance with a preferred embodiment of the present invention;

FIG. 2 is a top front right perspective view of the mist cooling assembly of FIG. 1;

FIG. 3 is a bottom front left perspective view of the mist cooling assembly of FIG. 1;

FIG. 4 is a bottom front right perspective view of the mist cooling assembly of FIG. 1;

FIG. 5 is a front view of the mist cooling assembly of FIG. 1;

FIG. 6 is a bottom view of the mist cooling assembly of FIG. 1;

FIG. 7 is a rear view of the mist cooling assembly of FIG. 1;

FIG. 8 is a top view of the mist cooling assembly of FIG. 1;

FIG. 9 is a cross-section view of the mist cooling assembly along line A-A of FIG. 8;

FIG. 10 is a left side view of the mist cooling assembly of FIG. 1;

FIG. 11 is a right side view of the mist cooling assembly of FIG. 1;

FIG. 12 is a perspective view of a fan for the mist cooling assembly of FIG. 1;

FIG. 13 is a schematic right side cross-sectional view of the mist cooling assembly of FIG. 1 in use;

FIG. 14 is a perspective view of a modified embodiment of the present invention;

FIG. 15 is a front view of the mist cooling assembly of FIG. 14;

FIG. 16 is a side view of the mist cooling assembly of FIG. 14; and

FIG. 17 is an exploded perspective view of the mist cooling assembly of FIG. 14;

### DETAILED DESCRIPTION OF SPECIFIC EMBODIMENTS

It should be noted in the following description that like or the same reference numerals in different embodiments denote the same or similar features.

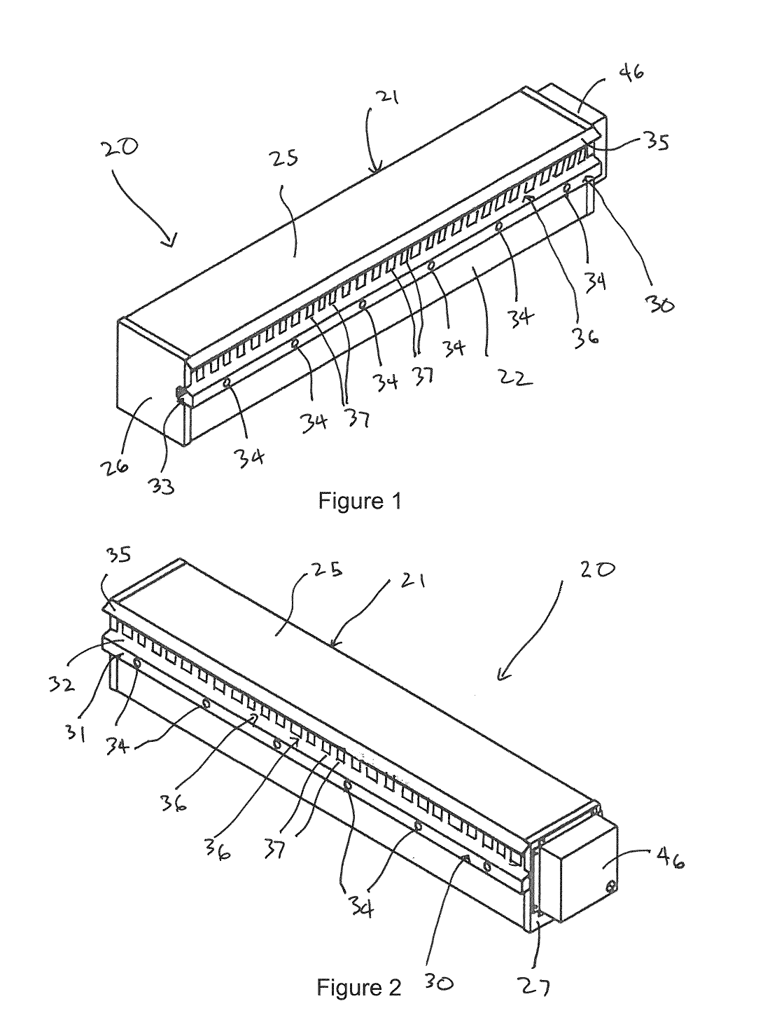

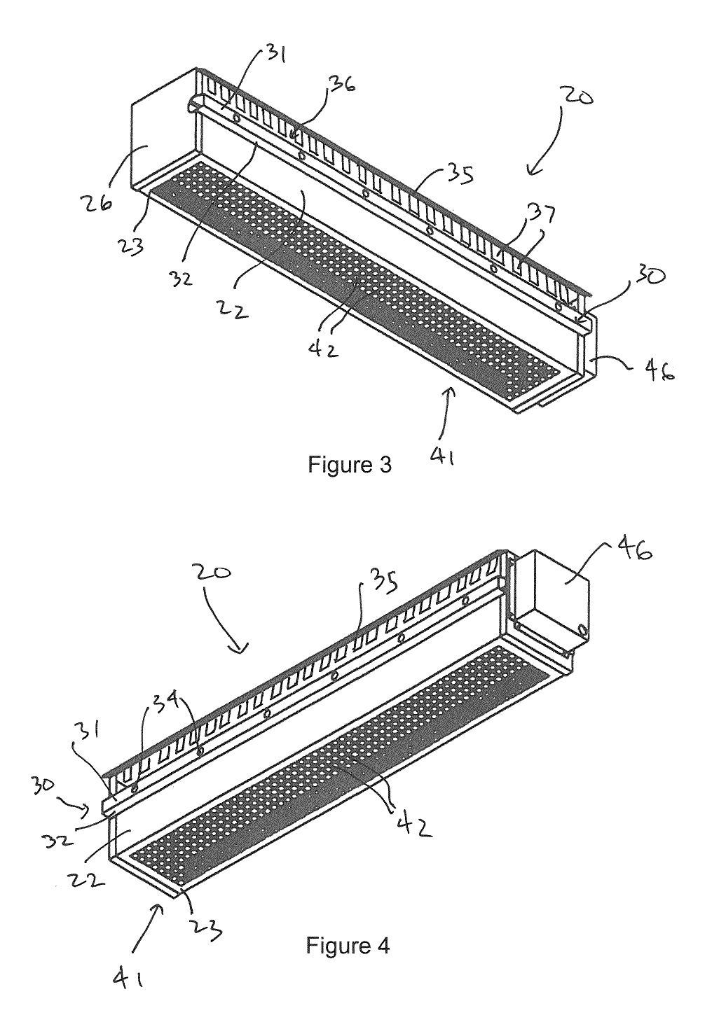

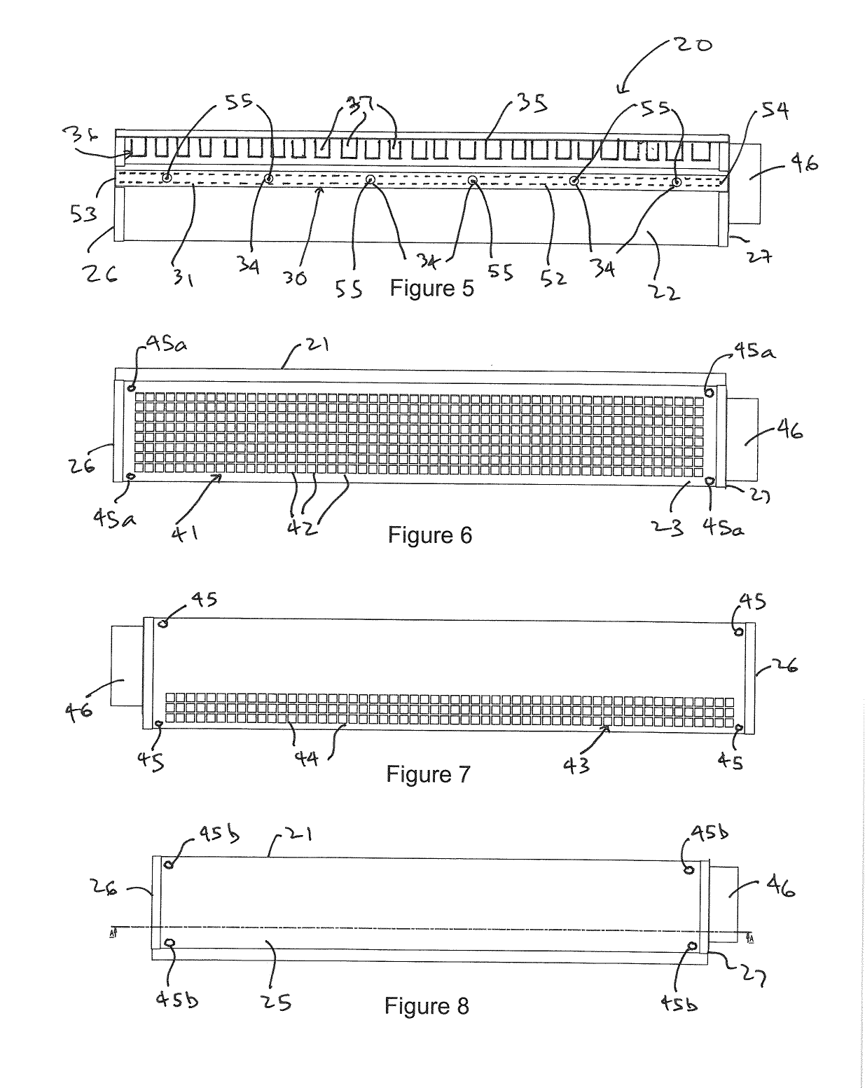

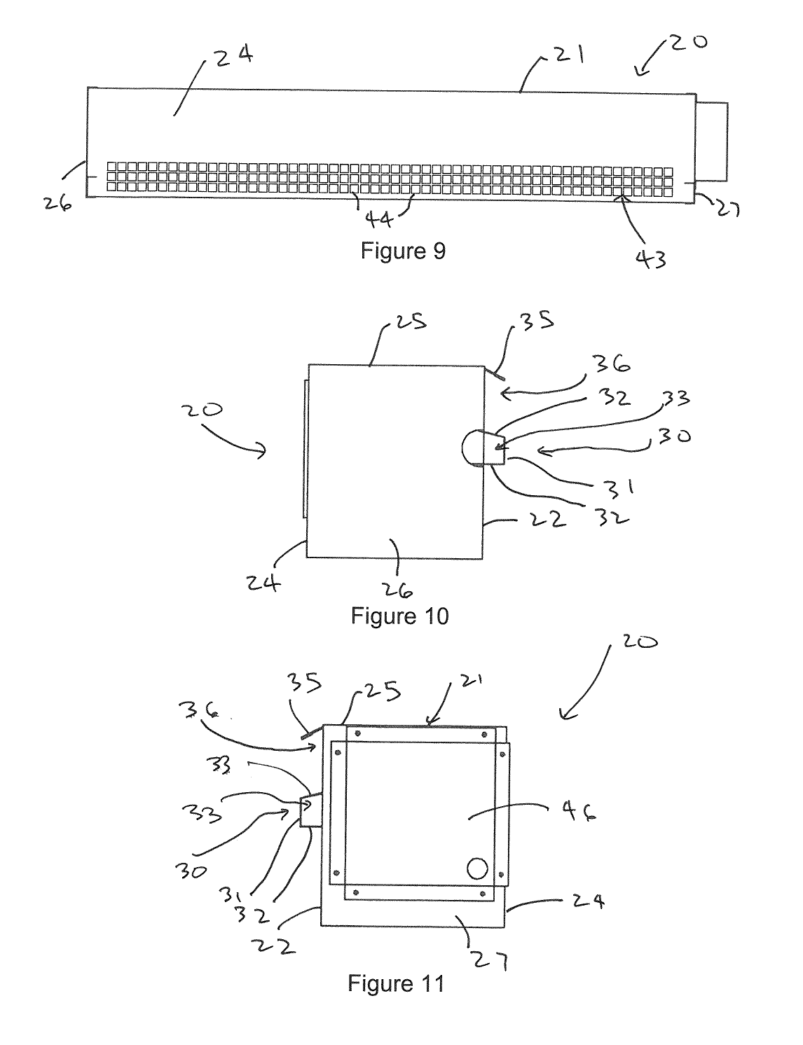

FIGS. 1 to 11 show a mist cooling assembly 20 according to a preferred embodiment of the present invention. The mist cooling assembly 20 includes a hollow housing 21 which is generally rectangular prism shaped. The housing 21 includes a front wall 22, a bottom wall 23, a rear wall 24, a top wall 25, a left side wall 26 and a right side wall 27. The walls 22 to 27 together define an internal space 28 (see FIG. 13) within the housing 21.

The front wall 22 comprises an air direction flange 35 at a top edge thereof, an air flow outlet 36 just below the flange 35, and a channel enclosure 30 below the air flow outlet 36. The flange 35, air flow outlet 36 and the channel enclosure 30 all extend horizontally substantially across the entire width of the front wall 22. The flange 35 is angled generally downwardly, for directing air exiting the air flow outlet 36 in a generally downward direction in use. The air flow outlet 36 comprises a series of rectangular apertures 37 spaced along the horizontal width of the front wall 22.

The channel enclosure 30 includes a base wall 31 and upper and lower webs 32. The base wall 31 is spaced from the front wall 22 and substantially parallel thereto. The upper and lower webs 32 extend generally outwardly from the front wall 22 to upper and lower edges respectively of the base wall 31. The base wall 31, webs 32 and portions of the front wall 22 together define an internal channel 33 within the channel enclosure 30. The base wall 31 includes six spaced misting unit apertures 34 formed along its width.

The bottom wall 23 includes a first air inlet 41, which comprises a plurality of square apertures 42 arranged in a grid array generally spanning the width and depth of the bottom wall 23.

The rear wall 24 includes a second air inlet 43 at a lower portion thereof, which comprises a plurality of square apertures 44 arranged in a grid array generally spanning the width of the rear wall 24. The rear wall 24 also includes mounting means for mounting the housing 21 to a structure. In the embodiment, the mounting means are apertures 45 formed adjacent corners of the rear wall 24. Additional mounting means 45a and 45b are formed respectively in the bottom wall 23 and the top wall 25.

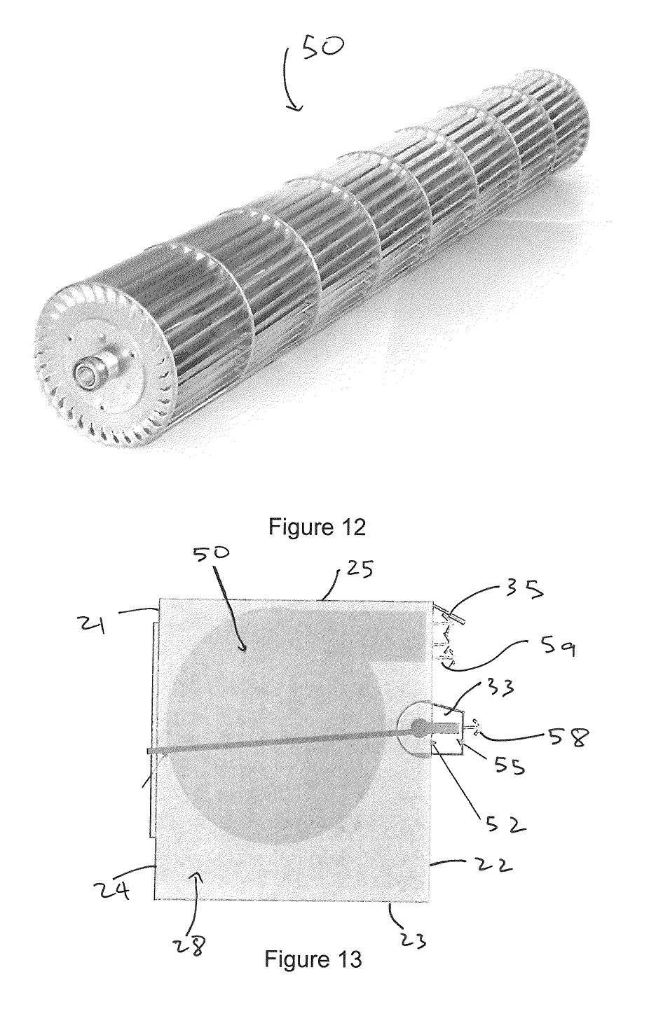

FIG. 12 shows a fan 50 for the mist cooling assembly 20. The fan 50 is an elongated centrifugal fan, also known as a cross flow fan. The fan 50 is located within the internal space 28 of the housing 21, and extends substantially the entire width of the housing 21. The fan 50 is driven by a motor (not shown) which is enclosed in a fan motor enclosure 46 attached to the right side wall 27 of the housing 21.

A delivery pipe 52 is disposed within the internal channel 33 of the channel enclosure 30. The delivery pipe 52 extends the width of the front wall 22 and includes an open end 53 adjacent the left side wall 26 and a closed end 54 adjacent the right side wall 27. The open end 53 is adapted for connection to a liquid supply source (not shown), such as a water pipe or tube. The delivery pipe 52 includes six misting outlets 55 disposed along its length which are respectively aligned with one of the misting apertures 34. The misting outlets 55 in the embodiment are water misting nozzles which are in communication with the delivery pipe 52.

In use, the housing 21 is mounted to a structure (not shown) in a substantially horizontal orientation, as generally shown in FIGS. 1 to 11 and 13. The housing 21 is mounted to a vertical surface of the structure (such as a wall) via the mounting apertures 45, an upwardly facing surface of the structure (such as a shelf or step) via the mounting apertures 45a, or a downwardly facing surface of the structure (such as a ceiling) via the mounting apertures 45b. Alternatively, any combination of the apertures 45 to 45b can be used for mounting the housing 21 to a structure using suitable brackets as desired.

The open end 53 of the delivery pipe 52 is then connected to a water supply pipe or tube. Water is supplied to the delivery pipe 52 via a high pressure pump which pressurizes the water to between 500 to 1000 psi, to expel the water as atomized mist via the misting nozzles 55. The nozzles 55 expel water mist in a substantially horizontal direction as indicated by arrow 58 (see FIG. 13). The fan 50 is actuated to suck in air through the first air inlet 41 and/or the second air inlet 43 and deliver a high velocity air flow (as indicated by arrow 59) out through the air flow outlet 36. The air flow 59 is thus delivered in a substantially horizontal direction, from slightly behind the water mist 58, and from above the water mist 58. Together with the air direction flange 35, the air flow 59 spreads the water mist 58 to a large area forward of the mist cooling assembly 20. It can be seen that the air flow outlet 36 delivers the air flow 59 toward each lateral side of each nozzle 55.

The mist cooling assembly 20 is typically mounted at a raised height relative to the area to be cooled. Thus, the water mist 58 is spread forward over a large area and drops down via gravity to effectively cool a large area.

A control system (not shown) with a timer is programmed to pump water into the delivery pipe 52 for a user determined period, at user determined specified intervals. Alternatively or additionally, the control system can include a temperature and/or humidity sensor and can respond to a change in temperature and/or humidity in the area to be cooled and actuate the pump as required. The control system can also be used to actuate the fan as required, or the fan can be actuated to run constantly. Alternatively, the assembly can be operated manually via a switch as desired.

The preferred embodiment thus provides a mist cooling assembly which provides a number of advantages. These include:

1. Noise Reduction—The fans of prior existing mist cooling systems are noisy and disruptive in hospitality and entertainment areas. The fan in the present embodiment is fully enclosed and as such the noise is suppressed and thus reduced.

2. Size—The fan in the present embodiment is compact having outer dimensions of approximately 200 mm×200 mm×1000 mm. For similar air flow produced, these dimensions are more compact than the fans used in prior systems.

3. Mounting—Prior systems use axial fans which need a substantial mounting point to attach to as the entire weight of the fan pivots on one attachment point. In the present embodiment, the fan is enclosed in a housing which can be attached at numerous vertical or horizontal points. Thus, the weight of the assembly is spread over a large area. The housing in the present embodiment can also be flush mounted to any vertical (wall) surface or any horizontal (ceiling, eves or roof) surface to provide a neat installation.

4. Appearance—Old style industrial fans used in prior systems are not attractive for up market locations such as hotels and restaurants. The present embodiment being housed in slim line housing and the fan being fully enclosed gives a neat and clean appearance that can be unobtrusively mounted in almost any location. The housing can also be powder coated in any color to blend with the existing décor.

The preferred embodiment thus provides a misting unit assembly which provides a number of substantial advantages. It will be apparent to skilled persons that modifications can be made to the above embodiment or that the invention can be embodied in other forms. For example, the fan can be replaced with a different type of fan within the housing, as long as the air flow is produced as desired. Also, the assembly can be made with any dimensions as desired, and can include less or more misting outlets to that shown. The housing can also be modified to be substantially circular to provide a different appearance if desired. The water pressure provided to the nozzles can also be less or more than that specified above, as suitable to the specific nozzle used, number of nozzles, and application. The fan used can also be shorter or longer than that specified in the embodiment.

In alternative embodiments, the air flow can be produced directly behind the misting nozzles or below the misting nozzles if desired. The assembly can also be modified to produce two or more air flows, for example one above and one behind/below the misting outlets if desired. The assembly can also be modified to include two or more fans if desired.

In another possible embodiment, the air flow source (fan) may not be housed in the housing. Instead, the assembly may include a tube for connection to an external air flow source (such as an air pump), with the air flow outlet directing the air flow in use.

The misting units in the embodiment are separate nozzles. In a possible alternative embodiment, the misting outlets can be misting apertures or outlets formed along the delivery pipe.

Also, the misting units in the embodiment are aligned along a straight line. However, the invention would be also effective even if the misting outlets are slightly offset from such a line.

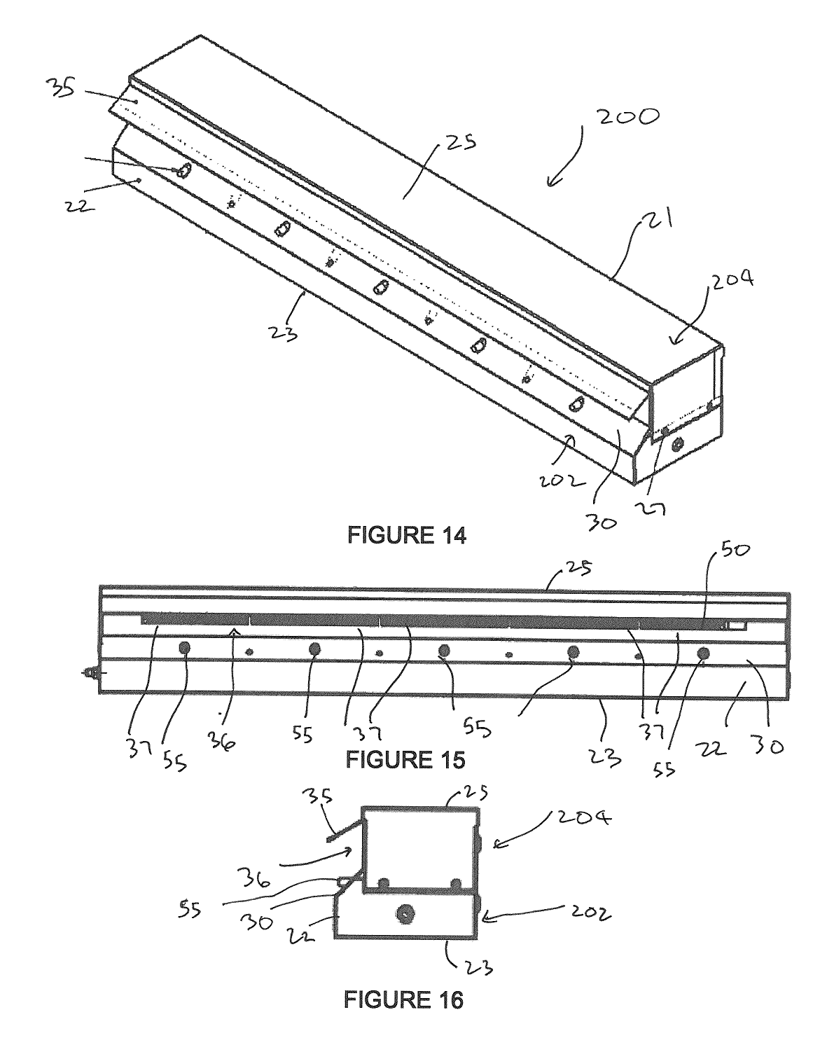

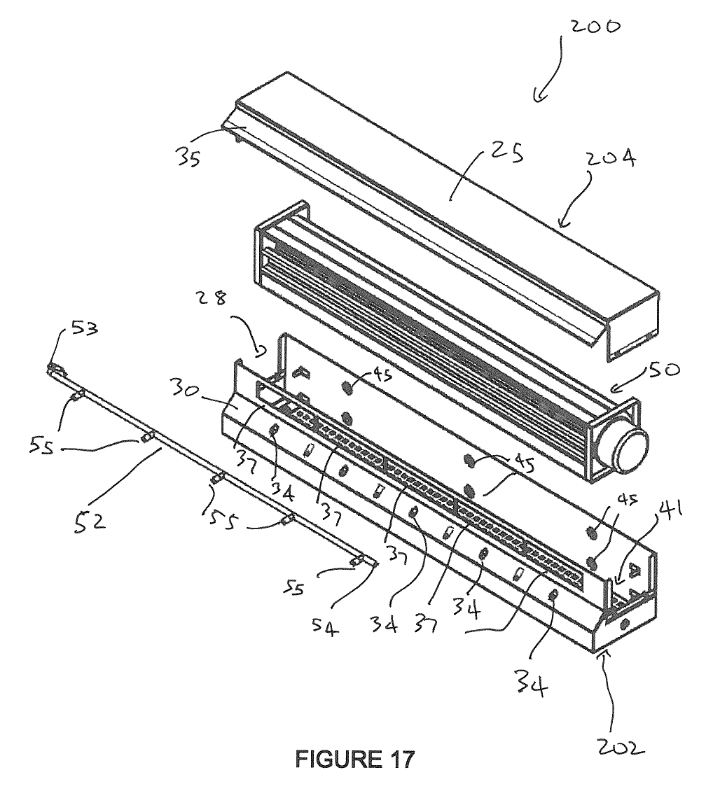

FIGS. 14 to 17 show a mist cooling assembly 200 according to a modified embodiment of the present invention, which is similar to the mist cooling assembly 20 above. The hollow housing 21 in this embodiment is made from two pieces and comprises a base piece 202 and a hood piece 204. The housing 21 similarly includes a front wall 22, a bottom wall 23, a rear wall 24, a top wall 25, a left side wall 26 and a right side wall 27.

The hood piece 204 forms the air direction flange 35 while the base piece 202 forms the air flow outlet 36. The rectangular apertures 37 are fewer and longer in the assembly 200 compared to the assembly 20. The channel enclosure 30 is an angled portion of the front wall 22. Other similar parts are similarly numbered.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the cooling industries.

Several embodiments of the present invention have been described. Nevertheless, it will be understood that various modifications may be made without departing from the spirit and scope of the invention. Accordingly, other embodiments are within the scope of the following claims.

What is claimed is:

1. A mist cooling assembly comprising:
a housing;
a plurality of water misting outlets generally aligned in a row along said housing, the misting outlets being spaced along a misting width; and
at least one air flow source disposed within said housing for supplying an air flow;
wherein the housing comprises at least one air flow outlet adapted to direct the air flow in use adjacent said misting outlets and substantially spanning the misting width.

2. The mist cooling assembly of claim 1 wherein the misting outlets are oriented to spray mist in use in a substantially horizontal direction.

3. The mist cooling assembly of claim 1 wherein the at least one air flow outlet directs the at least one air flow in use in a substantially horizontal direction.

4. The mist cooling assembly of claim 1 wherein the at least one air flow outlet directs the at least one air flow in use in a direction which is substantially parallel to the general direction of spray mist from the misting outlets.

5. The mist cooling assembly of claim 1 wherein the at least one air flow outlet directs the at least one air flow in use substantially from behind said misting outlets.

6. The mist cooling assembly of claim 1 wherein the at least one air flow outlet directs the at least one air flow in use substantially from above said misting outlets.

7. The mist cooling assembly of claim 1 wherein the at least one air flow outlet directs the at least one air flow in use substantially vertically spaced from said misting outlets.

8. The mist cooling assembly of claim 1 wherein the at least one air flow outlet delivers the air flow in use toward each lateral side of each nozzle.

9. The mist cooling assembly of claim 1 wherein the housing further comprises at least one air direction flange adjacent said at least one air flow outlet.

10. The mist cooling assembly of claim 9 wherein the at least one air direction flange is generally angled toward the misting outlets.

11. The mist cooling assembly of claim 1 wherein the misting outlets are disposed along a substantially horizontal axis.

12. The mist cooling assembly of claim 1 further comprising at least one liquid supply pipe, wherein the misting outlets are spaced along the at least one liquid supply pipe.

13. The mist cooling assembly of claim 12 wherein the misting outlets are nozzles.

14. The mist cooling assembly of claim 1 wherein the at least one air flow source comprises an elongated fan.

15. The mist cooling assembly of claim 12 wherein the housing comprises a plurality of spaced apertures respectively for said misting outlets.

16. The mist cooling assembly of claim 1 wherein the housing comprises at least one mounting means for mounting the housing to a structure.

17. A mist cooling assembly comprising:
a plurality of misting outlets generally aligned in a row; and
at least one air flow outlet for directing at least one air flow in use generally adjacent said misting outlets.

18. A method of cooling an area, the method comprising:
providing a plurality of misting outlets generally aligned in a horizontal row;
supplying water under pressure to said misting outlets to expel water as mist through said misting outlets in a substantially horizontal direction;
directing at least one air flow in a substantially horizontal direction adjacent and above said misting outlets to spread the expelled mist to the area to be cooled.

19. The method of claim 18 further comprising the step of:
directing the at least one air flow from a position disposed behind said misting outlets.

20. The method of claim 18 further comprising the step of:
directing the at least one air flow toward each lateral side of each nozzle.
